(19) United States
(12) Patent Application Publication
(10) Pub. No.: US 2008/0035850 A1
(43) Pub. Date: Feb. 14, 2008

(54) Optical detection of proximity of patient to a gamma camera

(76) Inventor: Donald Bak, Streamwood, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/504,799

(22) Filed: Aug. 14, 2006

(51) Int. Cl. G01T 1/166

(52) U.S. Cl. 250/363.05

(57) ABSTRACT

A patient on a bed is positioned within an imaging space defined by a view field of a signal detector for collecting imaging signals to be reconstructed into the images by using signal processing. The patient positioning system uses a nuclear detection device having a mechanism for generating nuclear radiation and detecting mechanism for detecting an incident nuclear radiation. The proximity units are comprised of modulated LED light sources emitting a carrier modulated light beam and a photo receiver. An analog/digital converter is used for receiving signals output by the photo receiver while a bandpass filter is used for selectively passing the carrier modulated light beam. A detector determines the presence or absence of the carrier modulated light beam. The absence or presence of the carrier modulated light beam determines the position of the patient.

### BACKGROUND

1. Field of the Invention

The present application relates to the precise positioning of a patient prior to performing an imaging procedure, and more particularly to methods and medical imaging apparatus for determining the position of a patient relative to a gamma camera using a frequency modulated LED and a digital signal processor which can include a photo receiver, an amplifier, an analog to digital converter, a bandpass filter and a signal detector.

2. Background Discussion

A gamma camera is an imaging device, most commonly used as a medical imaging device in nuclear medicine. It produces images of the distribution of gamma ray emitting radionuclides and generally consists of one or more detectors mounted on a gantry. The camera and gantry are connected to an acquisition system for operating the camera and for storing the images.

The system accumulates and counts gamma photons that are absorbed by a crystal in the camera, and crystal scintillates in response to incident gamma radiation. When the energy of an absorbed gamma photon is released, a faint flash of light is produced, similar to the photoelectric effect. Photomultiplier tubes behind the crystal detect the fluorescent flashes, sending the information to that in turn constructs and displays a two dimensional image of the relative spatial count density on a monitor. This image then reflects the distribution and relative concentration of radioactive tracer elements present in the organs and tissues imaged.

In order to obtain spatial information about the gamma emissions from fan imaging subject (e.g. a person's heart muscle cells which have absorbed an intravenous injected radioactive, usually thallium-201 or technetium-99, medicinal imaging agent) a method of correlating the detected photons with their point of origin is required.

The conventional method is to place a collimator over the detection crystal/PMT array. The collimator essentially consists of a thick sheet of lead, typically 1-3 inches thick, with thousands of adjacent holes through it. The individual holes limit photons that can be detected by the crystal to a cone with the point of the cone being at the midline center of any given hole and extending from the collimator surface outward. However, the collimator is also one of the sources of blurring within the image as lead does not completely attenuate incident gamma photons and there can be crosstalk between holes.

Unlike a lens, as used in visible light cameras, the collimator attenuates most (>99%) of the incident photons and thus greatly limits the sensitivity of the camera system. Large amounts of radiation must be present so as to provide enough exposure for the camera system to detect sufficient scintillation dots to form a picture. One way for the maximum amount of radiation to be presented to the collimators is exact positioning of the camera.

The importance of accurate patient positioning is well recognized in the art. For example, U.S. Pat. No. 5,273,043 relates to a medical imaging apparatus, such as a Single Photon Emission Computed Tomography apparatus (SPECT), an X-ray Computed Tomography (CT) apparatus, and a gamma camera apparatus, in which a patient on a bed is positioned inside an imaging space defined by a view field of a signal detector for collecting imaging signals to be reconstructed into the images by using signal processing. The patent notes that conventional SPECT apparatus have been associated with a problem that an accurate positioning of a target region of the patient within the effective view field of the gamma camera has been difficult such that a re-positioning of the patient in the cylindrical bore of the apparatus has often been necessary. The patent discloses a system for providing a simple way of ascertaining a correct positioning of the patient before the positioning of the patient inside the cylindrical bore, in order to minimize the need to put up with frequent and cumbersome repositioning of the patient.

U.S. Pat. No. 4,117,337 relates to the aligning and positioning of a patient and discloses the importance of precisely indicating the proper staged position of the patient and providing visible alignment patterns as a principal feature of the invention.

U.S. Pat. No. 5,276,615, discloses a nuclear detection device, especially a gamma-camera type device, with deconvolution filters having an inverse transfer function.

The present invention provides a variety of advances and improvements over, among other things, the systems and methods described in the foregoing and following references, the entire disclosures of which references are incorporated herein by reference.

### SUMMARY OF THE INVENTION

The present invention improves upon the above and/or other background technologies and/or problems therein. According to some embodiments, the present invention relates to a medical imaging apparatus such as a Single Photon Emission Computed Tomography apparatus, an X-ray Computed Tomography apparatus, and a gamma camera apparatus, in which a patient on a bed is positioned within an imaging space defined by a view field of a signal detector for collecting imaging signals to be reconstructed into the images by using signal processing.

A patient positioning system for a nuclear detection device having a mechanism for generating nuclear radiation and detecting mechanism for detecting an incident nuclear radiation. The patient positioning system is comprised of at least one proximity unit. Each of the proximity units are comprised of at least one light source, such as a LED, emitting a carrier modulated light beam and a photo receiver. The photo receivers are AC coupled to reduce sensitivity. It is also comprised of an analog/digital converter for receiving signals output by the photo receiver, a bandpass filter for selectively passing the carrier modulated light beam, and a detector determining means for determining the presence or absence of the carrier modulated light beam, whereby the absence or presence of the carrier modulated light beam determines the position of the patient. Each of the proximity units is activated sequentially.

The nuclear detection device used in the patient positioning system can be a gamma camera having multiple detector units on its face.

The patient positioning system can have multiple LED/Receiver combinations that have the same frequency transmit sequentially to the detection unit. Each detector unit has a different modulation. The frequency of modulation of the light source is outside the interference of ambient lighting. The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is a plan view of transmitter receiver in accordance with an embodiment of the invention;

FIG. 2 is a plan view of LED/photo receiver pairs in accordance with an embodiment of the invention; and

FIG. 3 is a plan view of an alternate embodiment with multiple LED/photo receivers transmitting data to a single detection unit.

### DISCUSSION OF THE PREFERRED EMBODIMENTS

While the present invention may be embodied in many different forms, a number of illustrative embodiments are described herein with the understanding that the present disclosure is to be considered as providing examples of the principles of the invention and that such examples are not intended to limit the invention to preferred embodiments described herein and/or illustrated herein.

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

For the purposes of the present invention, the term “ambient light” will refer to a combination of all light and/or signals that can be perceived by the receiver, within a room, no matter what the source. This would include LED generated light, carrier modulated light beam, gamma camera signal, overhead lights, examination lights, etc.

For the purposes of the present invention, the term “LED generated stray light” will refer to the light generated by an LED that is not directed to the receiver within the carrier modulated light beam.

For the purposes of the present invention, the term “modulation” is the addition of information (or a signal) to an electronic or optical signal carrier.

For the purposes of the present invention, the term “Digital Signal Processing” (DSP) is the processing of signals by digital means. A digital signal consists of a stream of numbers, usually (but not necessarily) in binary form. The processing of a digital signal is done by performing numerical calculations. A common need in electronics and DSP is to isolate a narrow band of frequencies from a wider bandwidth signal. The bandpass filter can serve to eliminate ambient light interference from an optical detector.

For the purposes of the present invention, the term “Tuned Filter”, in signal processing, is a stage in the processing channel that accepts or rejects signals that are tuned for a specific type or wavelength.

For the purposes of the present invention, the term “modulate” refers to varying the frequency, amplitude, phase, or other characteristic of electromagnetic waves, including modulating with a carrier wave. An LED is modulated at a known frequency and the coefficients of the bandpass filter are tuned for a narrow band at the modulated frequency.

For the purposes of the present invention, the term “carrier frequency” is used to designate the nominal frequency of a carrier wave, the center frequency of a frequency modulation signal.

For the purposes of the present invention, the term “bandpass filter” is an electronic device or circuit that allows signals between two specific frequencies to pass, but that discriminates against signals at other frequencies. Some bandpass filters require an external source of power and employ active components such as transistors and integrated circuits; these are known as active bandpass filters. Other bandpass filters use no external source of power and consist only of passive components such as capacitors and inductors; these are called passive bandpass filters

In a receiver, a bandpass filter allows signals within a selected range of frequencies to be heard or decoded, while preventing signals at unwanted frequencies from getting through and can serve to minimize interference or competition among signals. A bandpass filter also optimizes the signal-to-noise ratio (sensitivity) of a receiver.

Bandpass filters are used primarily in wireless transmitters and receivers. The main function of such a filter in a transmitter is to limit the bandwidth of the output signal to the minimum necessary to convey data at the desired speed and in the desired form. In a receiver, a bandpass filter allows signals within a selected range of frequencies to be heard or decoded, while preventing signals at unwanted frequencies from getting through. A bandpass filter also optimizes the signal-to-noise ratio (sensitivity) of a receiver. In both transmitting and receiving applications, well-designed bandpass filters, having the optimum bandwidth for the mode and speed of communication being used, maximize the number of signals that can be transferred in a system, while minimizing the interference or competition among signals.

The prior art patient detection systems generally use an optical interrupter system to report when the patient is in close proximity to the detector to profile the patient during gamma camera studies. The system activates an LED on one side of the patient detection system and monitors the signal on the opposite side. Multiple LED's and receivers line the length of the system and are sequentially activated until the complete area of the detector is monitored for patient proximity. A shortcoming of this mechanism is that the receivers can false trigger on ambient light, signals from the second gamma camera with a patient detection system, and are sensitive to production variations in LEDs and receivers.

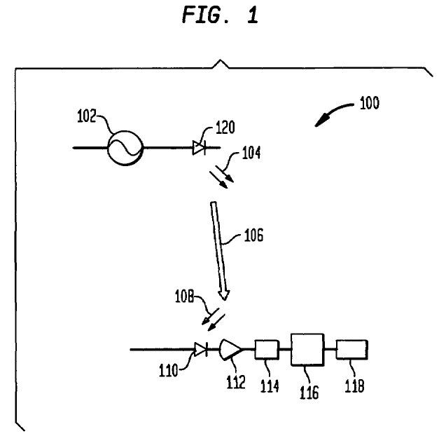

As shown in FIG. 1, the transmitter system indicated generally as 100 includes an AC source 102 and a LED 120, which has been modulated at a known frequency with a carrier beam 106. The carrier light beam 106 is then directed at the photo receiver 110. The photo receiver 110 receives, in addition to the directed carrier modulated light beam 106, LED 120 generated stray light 104, ambient light 108 as well as signals from the second gamma camera, if used. To prevent the false trigger of prior art systems, the disclosed system process the signals using the signal modulation. The combination of light from the carrier modulated light beam 106, LED 120 generated stray light 104, ambient light 108 and second gamma camera, is amplified at amplifier 112 and then converted at the analog to digital converter 114 to a digital signal.

The digital signal is then filtered in a bandpass filter 116, the coefficients of which have been tuned for a narrow band at a frequency that matches the frequency of the carrier modulated light beam 106. This filtering eliminates the unrelated signals from adjacent LEDs 120 stray light 104, ambient light 108 and gamma camera signals, sending only the predetermined frequency of the carrier modulated light beam 106 to the detector 118. The detector 118 then determines whether the signal transmitted with the carrier modulated light beam 106 is absent or present.

In one embodiment a LED 120 and its carrier modulated beam 106, photo receiver 110, analog to digital converter 114, bandpass filter 116, and detector 118 all form one proximity unit 100. A detection system comprises multiple proximity units 100 along the face of the camera. The proximity unit 100 enables simultaneous activation of all proximity units 100. In another embodiment, the LED and the photoreceiver 110 are separated by a substantial distance, such as having the LED on the gamma camera and the photoreceiver on a bed.

The gain of the system can be compensated by digitally adjusting the coefficients of the filter and detector during a factory or field calibration and the system can be designed to be tolerant of component variations.

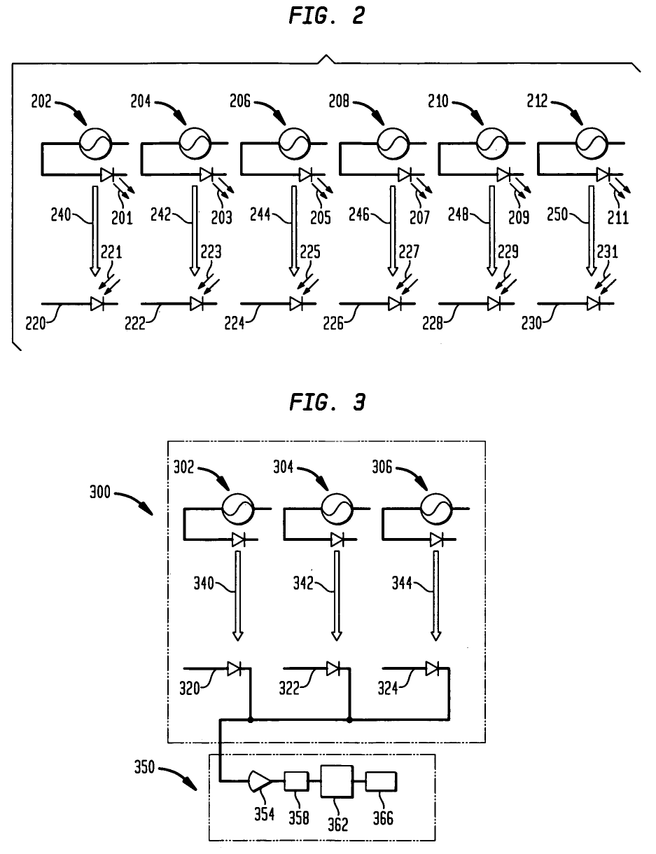

A complete patient detection system is illustrated in FIG. 2, where the LED and photo receiver combinations line the face of the gamma camera (not shown). Each LED 202, 204, 206, 208, 210, and 212, is modulated with a carrier modulated light beam 240, 242, 244, 256, 248 and 250, respectively. These carrier modulated light beams 240, 242, 244, 256, 248 and 250 are detected by the respective corresponding photo receiver, 220, 222, 224, 226, 228, and 230, and processed by the digital signal process components as noted in relation to FIG. 1.

The pairs of LED transmitters 202, 204, 206, 208, 210, and 212 are seen to generate LED generated stray light indicated as 201, 203, 205, 207, 209, and 211. Similarly, each receiver is subjected to ambient light 221, 223, 225, 227, 229, and 231, in addition to carrier modulated light beam 240, 242, 244, 246, 248, and 250 from its paired LED transmitter 202, 204, 206, 208, 210, and 212. The received light is digitally processed, as noted in regard to FIG. 1.

The frequency of modulation can be different for each patient detection system on a gamma camera, thus suppressing interference from other systems. The frequency selected is outside the interference range of ambient lighting (120 HZ and 100 HZ) sources. The receivers can be AC coupled to reduce sensitivity to incandescent and sun light.

In addition to operating each LED/photo receiver pair sequentially, the system can activate multiple pairs at different frequencies to reduce the time to detect patient presence. The simultaneous use of multiple patient presence detectors would not be possible with the DC interrupter systems, due to interference between LED/photo receiver pairs.

In an alternative embodiment, illustrated in FIG. 3, the signal received from a LEDs 302, 304 and 306, carrier modulated beams 340, 342 and 344, and photo receivers 320, 322, and 324, forms a LED/Receiver combination 300. Signals received from the LED/Receiver combination unit 300 are transmitted to a detection unit 350 that comprises an amplifier 354, an analog to digital converter 358, bandpass filter 362, and detector 366. In this system, the carrier modulated beams 340, 342 and 344 would need to be sent separately to the respective receivers 320, 322 and 324 to avoid interference.

A detection system can have any number of LEDs and photo receivers feeding into a bandpass filter. As each bandpass filter can only be set to pass one frequency, each separate frequency must have its own bandpass filter with the LED/receivers on each frequency being activated sequentially.

The number of simultaneous beams is limited only by the number of available frequencies that can be assigned to the multiple detectors, selectivity of the digital signal processing system, and the number of analog and analog to digital converters that can be allocated to the system.

To further reduce the immunity to noise and interference, the modulation of the LEDs can be encoded at the carrier with a known pattern that is detected after the digital signal processing in the receiver. The encoding can be unique for each simultaneously used LED/photo receiver pair.

It is thus seen that the system of the present invention modulates the LEDs with a carrier and uses a DSP mechanism to create a tuned filter at the LED carrier frequency to identify the presence or absence of a signal. Absence of a signal indicated that a patient is positioned between the LED and the detector.

### BROAD SCOPE OF THE INVENTION

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

What is claimed is:

1. A patient positioning system for a nuclear detection device, said nuclear detection device having a mechanism for generating nuclear radiation and detecting mechanism for detecting an incident nuclear radiation, said patient position system comprising:
at least one proximity unit, each of said at least one proximity unit comprising:
a light source, said at least one light source emitting a carrier modulated light beam,
a photo receiver,
an analog/digital converter for receiving signals output by said photo receiver,
a bandpass filter, for selectively passing said carrier modulated light beam, and
a detector determining means for determining the presence or absence of said carrier modulated light beam,
whereby the absence or presence of said carrier modulated light beam determines the position of said patient.

2. The patient positioning system of claim 1, wherein said nuclear detection device is a gamma camera.

3. The patient positioning system of claim 2 wherein said gamma camera has multiple detector units on the face of said gamma camera.

4. The patient positioning system of claim 1, wherein said light source a modulated LED.

5. The patient positioning system of claim 1 wherein each detector unit has a different modulation.

6. The patient position system of claim 1 wherein the frequency of modulation of said light source would be outside the interference of ambient lighting.

7. The patient positioning system of claim 1 wherein said photo receivers are AC coupled to reduce sensitivity.

8. The patient positioning system of claim 1 wherein said at least one proximity unit is a plurality of units activated sequentially.

9. A patient positioning system for a nuclear detection device, said nuclear detection device having a mechanism for generating nuclear radiation and detecting mechanism for detecting an incident nuclear radiation, said patient position system comprising:
at least one LED transmitter/Receiver combination, each of said at least one LED transmitter/Receiver combination comprising:
a light source, said at least one light source emitting a carrier modulated light beam,
a photo receiver,
a detection unit, said detection unit comprising:
an analog/digital converter for receiving signals output by said photo receiver,
a bandpass filter, for selectively passing said carrier modulated light beam, and
a detector determining means for determining the presence or absence of said carrier modulated light beam,
whereby the absence or presence of said carrier modulated light beam determines the position of said patient.

10. The patient positioning system of claim 9, wherein said nuclear detection device is a gamma camera.

11. The patient positioning system of claim 10 wherein said gamma camera has multiple detector units on the face of said gamma camera.

12. The patient positioning system of claim 9, multiple LED transmitter/Receiver combinations having the same frequency transmit sequentially to said detection unit.

13. The patient positioning system of claim 9 wherein each LED transmitter unit has a different modulation.

14. The patient position system of claim 9 wherein the frequency of modulation of said light source is outside the frequency range of ambient lighting.

15. The patient positioning system of claim 9 wherein said photo receivers are AC coupled to reduce sensitivity.

16. The method of patient positioning in a nuclear detection device, said nuclear detection device having a mechanism for generating nuclear radiation and detecting mechanism for detecting an incident nuclear radiation, said patient position system comprising the steps of:
transmitting a carrier modulated light beam,
receiving light in a photo receiver,
converting analog signals output by said photo receiver to digital signals,
selectively passing only said carrier modulated light beam through a bandpass filter,
determining the presence or absence of said carrier modulated light beam from said bandpass filter,
determining the position of said patient by the absence or presence of said carrier modulated light beam.

16. The method of claim 15, wherein said nuclear detection device is a gamma camera.

17. The method of claim 15, further comprising the step of sequentially generating carrier modulated light beams in a plurality of LED transmitters, said carrier modulated light beams having the same frequency.

18. The method of claim 15, further comprising the step of simultaneously generating carrier modulated light beams in a plurality of LED transmitters, each of said LED transmitter units having a different modulation.

19. The method of claim 15, wherein the frequency of modulation of said light source is outside the frequency range of ambient lighting.
